(19) United States
(12) Patent Application Publication
(10) Pub. No.: US 2007/0266872 A1
(43) Pub. Date: Nov. 22, 2007

(54) Apparatus for drying sheets in a sheet-fed printing press and sheet-fed printing press having the apparatus

(75) Inventors: Jurgen Albrecht, Eppelheim (DE); Peter Hachmann, Dossenheim (DE); Rolf Muller, Nussloch (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/804,278

(22) Filed: May 17, 2007

(30) Foreign Application Priority Data
May 17, 2006 (DE) 10 2006 023 077.9

(51) Int. Cl. B41F 35/00

(52) U.S. Cl. 101/424.1

(57) ABSTRACT

An apparatus for drying sheets in a sheet-fed printing press includes a hot air dryer having a hot-air outflow temperature which is at least 300° C. A sheet-fed printing press having the apparatus is also provided.

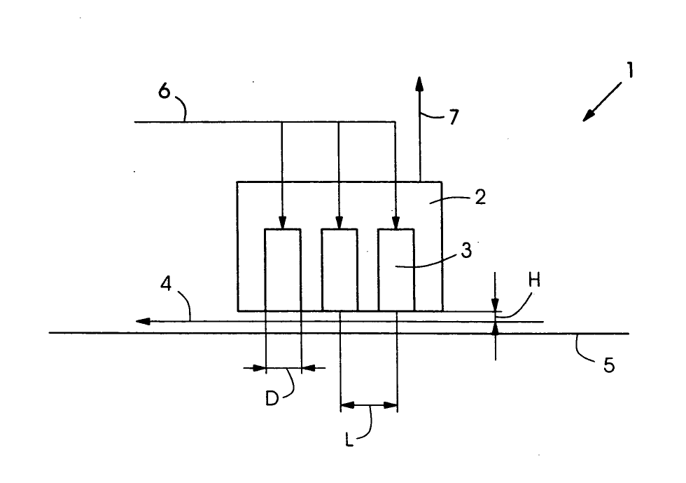

### CROSS-REFERENCE TO RELATED APPLICATION:

This application claims the priority, under 35 U.S.C. §119, of German Patent Application DE 10 2006 023 077.9, filed May 17, 2006; the prior application is herewith incorporated by reference in its entirety.

### BACKGROUND OF THE INVENTION

### FIELD OF THE INVENTION

The invention relates to an apparatus for drying sheets in a sheet-fed printing press having a hot air dryer with a hot-air outflow temperature. The invention also relates to a sheet-fed printing press having the apparatus.

The invention has been produced against the following background: hot air dryers serving for drying printing-material webs in web-fed printing presses differ in principle from hot air dryers serving for drying printing-material sheets in sheet-fed printing presses, due to the different requirements thereof. In particular, the outflow temperature of the hot air is considerably higher in the hot air dryers serving for drying printing-material webs than in the hot air dryers serving for drying printing-material sheets.

For example, German Translation DE 691 26 148 (T2), which corresponds to European Patent 0 629 500 B1 and to U.S. Pat. No. 5,203,092, describes a hot air dryer having a burner which maintains recirculated hot air at a temperature of up to 250° C. In contrast, European Patent 0 647 524 B1, which corresponds to U.S. Pat. No. 6,293,196, describes an apparatus for drying sheets in a sheet-fed printing press, the apparatus including a hot air drier with a hot-air outflow temperature of 176° C.

There are various reasons for the outflow temperature of the hot air dryers of the sheet-fed printing presses to be lower than that of the hot air dryers of the web-fed printing presses. For one, when drying printing material sheets there is a greater risk that the printing material will warp due to the thermal loading by the hot air. Reference is made to that risk, for example, in German Published, Non-Prosecuted Patent Application DE 101 58 050 A1. For another, particularly in sheet-fed printing presses, there is a risk of excessive thermal loading, by the hot air, of those parts which are situated in the surroundings of the hot air dryer. For example, in sheet-fed printing presses, the hot air dryers are often disposed in the vicinity of varnishing cylinders, with the result that the hot air which escapes and rises upwardly into the surroundings, after impinging on the sheet which is to be dried, threatens to dry the varnish on the rubber blanket of the varnishing cylinder. If the hot air drier is disposed in the vicinity of a chain conveyor of a sheet delivery of the sheet-fed printing press, which is also often the case, there is the risk that the hot air, which escapes into the surroundings, may excessively heat the chains of the chain conveyor, with the result that grease serving to lubricate the chains will liquefy to an excessively pronounced extent and will consequently drip out of the chains, thereby impairing the function of the chains. Reference is made in Published European Patent Application 1 068 954 A1 to the risk of excessive temperature loading of a printing unit of a sheet-fed printing press, in which the printing unit is adjacent the hot air dryer.

For the hereinafore-mentioned reasons, efforts were made in the past to keep the outflow temperature of the hot air dryer low. In order to compensate to a certain extent for the consequently low efficiency of the hot air dryer, drying of the sheet took place over a comparatively long drying stretch or distance. In order to be able to dry the sheet over that long drying stretch, a correspondingly long hot air dryer had to be used.

In order to increase the efficiency of the hot air dryer of the sheet-fed printing press, it has been proposed in German Published, Non-Prosecuted Patent Application 10 2005 010 992 A1, which corresponds to U.S. Patent Application Publication No. US 2005/0217523, to optimize various parameters of nozzles of the hot air dryer. Although the efficiency can be improved to a certain extent by the proposed optimization, it cannot, however, be improved to the desired extent. A cause thereof is assumed to be an excessively low thermal transfer of the heat of the hot air onto the printing material sheet.

### SUMMARY OF THE INVENTION

It is accordingly an object of the invention to provide an apparatus for drying sheets in a sheet-fed printing press and a sheet-fed printing press having the apparatus, which overcome the hereinafore-mentioned disadvantages of the heretofore-known devices of this general type and in which the hot air dryer ensures a degree of efficiency which is even further improved.

With the foregoing and other objects in view there is provided, in accordance with the invention, an apparatus for drying sheets in a sheet-fed printing press. The apparatus comprises a hot air dryer having a hot-air outflow temperature. The outflow temperature is at least 300° C.

A high outflow temperature of this type ensures a high energy density and high energy coupling (thermal transfer) into the surface of the printed sheet. The ink or varnish layers which are situated on the printed sheet are warmed and dried very rapidly. In this case, excessively pronounced thermal conduction into the depth of the material of the printed sheet and, as a consequence, warping of the printed sheet, are avoided. Due to the satisfactory efficiency of the hot air dryer of the apparatus according to the invention, the drying section which is required for sheet drying can be shortened, and a compact overall shape of the hot air dryer is achieved. Contrary to expectations, the risk of excessive thermal loading of machine parts which are disposed in the surroundings of the hot air dryer does not exist if a favorable installation location is selected for the hot air dryer and the hot air dryer is optimized in structural terms. With its outflow temperature which is at least 300° C. and is selected to be extremely high for apparatuses for drying sheets, the invention overcomes a series of prejudices which have previously existed.

In accordance with another feature of the invention, the outflow temperature is at least 350° C.

In accordance with a further feature of the invention, the hot air dryer includes nozzles from which hot air flows. The nozzles have a nozzle-effective spacing of less than 20 millimeters from the respective sheets to be dried.

In accordance with an added feature of the invention, the nozzle-effective spacing is less than 10 millimeters.

In accordance with an additional feature of the invention, each of the nozzles has a respective outflow diameter which is greater than one tenth of the nozzle-effective spacing and smaller than one-half of the nozzle-effective spacing.

In accordance with yet another feature of the invention, a nozzle center spacing is provided between respectively adjacent nozzles. The nozzle center spacing is greater than the nozzle effective spacing and smaller than three times the nozzle effective spacing.

With the objects of the invention in view, there is concomitantly provided a sheet-fed printing press having the apparatus according to the invention.

Other features which are considered as characteristic for the invention are set forth in the appended claims.

Although the invention is illustrated and described herein as embodied in an apparatus for drying sheets in a sheet-fed printing press and a sheet-fed printing press having the apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawing.

### BRIEF DESCRIPTION OF THE DRAWING

The FIGURE of the drawing is a fragmentary, highly diagrammatic, side-elevational view of a sheet-fed printing press.

### DESCRIPTION OF THE PREFERRED EMBODIMENT

Referring now in detail to the single FIGURE of the drawing, there is seen a sheet-fed printing press 1 which includes a hot air dryer 2 having nozzles 3 that are disposed in a pattern. A sheet 4 or the printing ink disposed thereon is dried by hot air ejected from the nozzles 3, and the respective sheet 4 is transported past the hot air dryer 2 by a suitable transport apparatus 5.

The transport apparatus 5 is a transport belt but may, instead, be a cylinder, for example an impression cylinder, of the printing press 1. The transport apparatus 5 transports the sheet 4 in a sheet travel direction which is indicated symbolically in the FIGURE by an arrow.

The nozzles 3 are connected to a hot air feeder 6, and the hot air which is ejected from the nozzles 3 is extracted again by an extraction device 7, after the hot air has impinged on the sheet 4 and has imparted part of the warmth thereof to the sheet 4. The nozzles 3 are configured as so-called round nozzles having circular nozzle openings which, respectively, define an outflow diameter D.

A nozzle effective spacing H is to be measured between outlet mouths or nozzle openings of the nozzles 3 and the sheet 4, toward or onto which the nozzles 3 are directed. The transport device 5 and the hot air dryer 2 are positioned adjacent one another in such a manner that the nozzle effective spacing H is ensured.

A further parameter important for functioning or operation is a nozzle center spacing L, at which respective adjacent nozzles 3 are situated with respect to one another in longitudinal rows and within transverse rows of the nozzle pattern. The nozzle center spacing L is to be measured between the respective nozzles 3 following one another in the longitudinal row in a direction which is parallel to the sheet travel direction, and is to be measured between nozzles 3 following one another in the respective transverse row in a direction which is perpendicular to the sheet travel direction. The nozzle center spacing L can vary slightly within the nozzle pattern and can, for example, be slightly different within the longitudinal rows than within the transverse rows.

The nozzle effective spacing H can also be slightly different from nozzle 3 to nozzle 3. In every case, the nozzle effective spacing H is smaller than 20 millimeters and preferably smaller than 10 millimeters.

The outflow diameter D measured at the nozzle openings is greater than one tenth of the nozzle effective spacing H and is smaller than half of this nozzle effective spacing H. The nozzle center spacing L is greater than the nozzle effective spacing H and smaller than three times the nozzle effective spacing H.

It is decisive that the hot air which is ejected from the nozzles 3 for drying the sheet 4 has an outflow temperature which is greater than 300° C. and is preferably greater than 350° C.

We claim:

1. An apparatus for drying sheets in a sheet-fed printing press, the apparatus comprising:
a hot air dryer ejecting hot air onto the sheets with a hot-air outflow temperature;
said outflow temperature being at least 300° C.

2. The apparatus according to claim 1, wherein said outflow temperature is at least 350° C.

3. The apparatus according to claim 1, wherein said hot air dryer further comprises:
nozzles from which the hot air flows;
said nozzles having a nozzle-effective spacing of less than 20 millimeters from the respective sheets to be dried.

4. The apparatus according to claim 3, wherein said nozzle-effective spacing is less than 10 millimeters.

5. The apparatus according to claim 3, wherein each of said nozzles has a respective outflow diameter which is greater than one tenth of said nozzle-effective spacing and smaller than one-half of said nozzle-effective spacing.

6. The apparatus according to claim 5, further comprising:
a nozzle center spacing provided between respectively adjacent nozzles;
said nozzle center spacing being greater than said nozzle effective spacing and smaller than three times said nozzle effective spacing.

7. A sheet-fed printing press, comprising an apparatus according to claim 1.
